(19) United States
(12) Patent Application Publication
(10) Pub. No.: US 2024/0402308 A1
(43) Pub. Date: Dec. 5, 2024

(54) DISTANCE MEASURING SYSTEM

(71) Applicants: Hiroyoshi Sekiguchi, KANAGAWA (JP); Naoki Shinoda, KYOTO (JP)

(72) Inventors: Hiroyoshi Sekiguchi, KANAGAWA (JP); Naoki Shinoda, KYOTO (JP)

(73) Assignee: Ricoh Company, Ltd., Tokyo (JP)

(21) Appl. No.: 18/670,929

(22) Filed: May 22, 2024

(30) Foreign Application Priority Data
May 29, 2023 (JP) 2023-088219

(51) Int. Cl. G01S 7/4861; G01S 7/4865; G01S 17/26

(52) U.S. Cl. CPC G01S 7/4861; G01S 7/4865; G01S 17/26

(57) ABSTRACT

A distance measuring system includes circuitry configured to calculate quantum correlation information based on first light and second light quantum-entangled with the first light, perform inference based on the quantum correlation information to obtain inference results, and output the inference results.

### CROSS-REFERENCE TO RELATED APPLICATIONS

This patent application is based on and claims priority pursuant to 35 U.S.C. § 119 (a) to Japanese Patent Application No. 2023-088219, filed on May 29, 2023, in the Japan Patent Office, the entire disclosure of which is hereby incorporated by reference herein.

### BACKGROUND

### Technical Field

The present disclosure relates to a distance measuring system.

### Related Art

In the related art, a distance measuring system such as light detection and ranging (LiDAR) is known. In a distance measuring system, the pulsed light emitted from a laser light source is projected, the reflected light of the projected light by an object is received, and the distance to the object is measured based on a time difference between the projection of the pulsed light and the reception of the reflected light.

In a light projecting-and-receiving technique, with respect to a frequency-entangled photon pair including a first photon and a second photon, the first photon is transmitted along a first optical path and the second photon is transmitted along a second optical path, and the photon transmitted along the first optical path is detected by a first detector, and the photon transmitted along the second optical path is detected by a second detector.

### SUMMARY

An embodiment of the present disclosure provides a distance measuring system including circuitry configured to: calculate quantum correlation information based on first light and second light quantum-entangled with the first light; perform inference based on the quantum correlation information to obtain inference results; and output the inference results.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a block diagram illustrating a configuration of a light emitting and receiving device according to a first embodiment of the present disclosure;

FIG. 2 is a block diagram illustrating a functional configuration of the light emitting and receiving device according to the first embodiment;

FIG. 3 is a block diagram illustrating a configuration of a light emitting and receiving device according to a modification of the first embodiment;

FIG. 4 is a block diagram illustrating a configuration of a distance measuring system according to a second embodiment of the present disclosure;

FIG. 5 is a block diagram illustrating a hardware configuration of an analyzer according to the second embodiment;

FIG. 6 is a block diagram illustrating a functional configuration of the analyzer according to the second embodiment;

FIG. 7 is a flowchart of processing processed by the analyzer according to the second embodiment;

FIG. 8 is a block diagram illustrating a configuration of a distance measuring system according to a modification of the second embodiment;

FIG. 9 is a block diagram illustrating a configuration of a distance measuring system according to a third embodiment of the present disclosure;

FIG. 10 is a block diagram illustrating a configuration of a distance measuring system according to a modification of the third embodiment;

FIG. 11 is a block diagram illustrating a configuration of a distance measuring system according to a fourth embodiment of the present disclosure;

FIG. 12 is a block diagram illustrating a functional configuration of an analyzer according to the fourth embodiment;

FIG. 13 is a flowchart of processing processed by the analyzer according to the fourth embodiment;

FIG. 14 is a block diagram illustrating a configuration of a distance measuring system according to a fifth embodiment of the present disclosure;

FIG. 15 is a block diagram illustrating a functional configuration of an analyzer according to the fifth embodiment;

FIG. 16 is a block diagram illustrating a functional configuration of a light emitting and receiving device according to the fifth embodiment;

FIG. 17 is a flowchart of operation performed by the distance measuring system according to the fifth embodiment;

FIG. 18 is a flowchart of operation performed by the distance measuring system according to a modification of the fifth embodiment;

FIG. 19 is a block diagram illustrating a configuration of a distance measuring system according to a sixth embodiment of the present disclosure;

FIG. 20 is a block diagram illustrating a functional configuration of an analyzer according to the sixth embodiment; and

FIG. 21 is a flowchart of operation performed by the distance measuring system according to the sixth embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

According to one aspect of the present disclosure, a distance measuring system that performs inference based on light in a quantum entangled state.

Embodiments of the present disclosure will be described with reference to the accompanying drawings. In the present specification and drawings, the same reference numerals are given to the components having substantially the same functional configurations, and the redundant description may be omitted.

A light emitting and receiving device according to an embodiment is mounted on a measurement system such as a distance measuring system, projects light to be used in measurement, and receives light reflected from an object to be measured. Further, a distance measuring system according to an embodiment includes the light emitting and receiving device according to an embodiment, projects pulsed light from the light emitting and receiving device, receives reflected light of the pulsed light reflected from an object, and measures a distance to the object based on a time difference between the projection of the pulsed light and the reception of the reflected light.

### First Embodiment

### Configuration of Light Emitting and Receiving Device According to First Embodiment

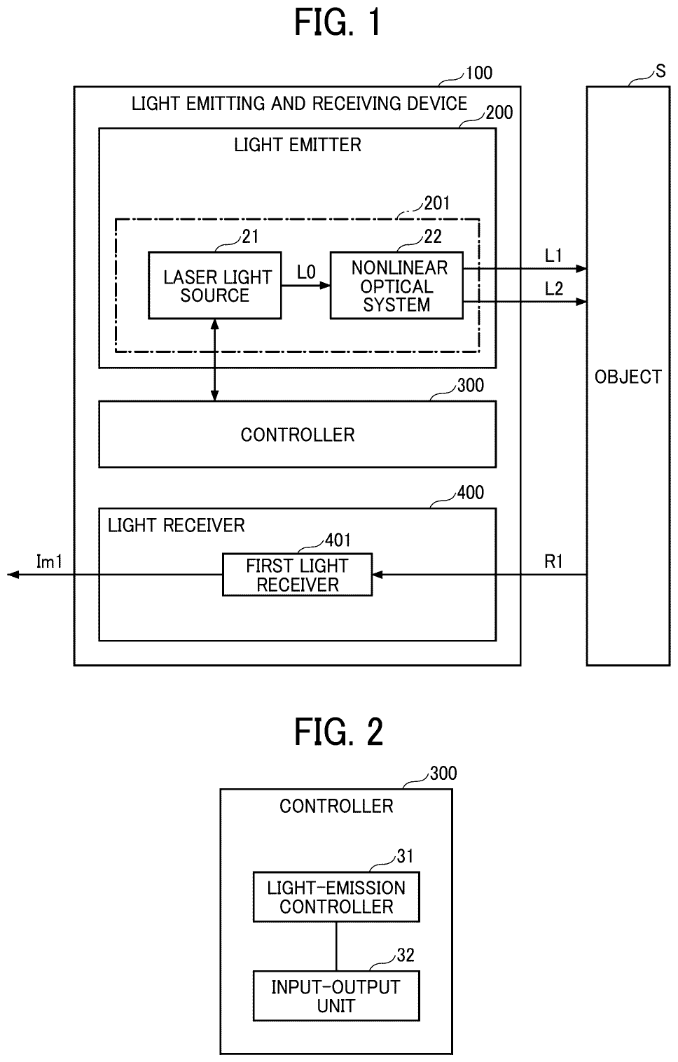

A configuration of the light emitting and receiving device will be described with reference to FIGS. 1 and 2. FIG. 1 is a block diagram illustrating an example of a configuration of a light emitting and receiving device 100 according to a first embodiment of the present disclosure. FIG. 2 is a block diagram illustrating an example of a functional configuration of a controller 300 in the light emitting and receiving device 100.

As illustrated in FIG. 1, the light emitting and receiving device 100 includes a light emitter 200, the controller 300, and a light receiver 400.

The light emitter 200 includes a first light emitter 201 that emits first light L1 and second light L2 that are in a quantum entangled state with each other. The light emitter 200 generates, for example, a photon pair of quantum entangled light including the first light L1 and the second light L2. The photon pair of quantum entangled light includes signal light and idler light, and the signal light and the idler light are in a quantum entangled state with each other. In this case, the first light L1 corresponds to the signal light, and the second light L2 corresponds to the idler light.

For example, a spontaneous parametric down-conversion (SPDC) can be used for the light emitter 200.SPDC) can be employed. The light emitter 200 includes a laser light source 21 and a nonlinear optical crystal 22. The laser light source 21 is, for example, a semiconductor laser, and emits excitation light L0 toward the nonlinear optical crystal 22. The nonlinear optical crystal 22 is a type-I nonlinear optical crystal, and emits the first light L1 and the second light L2 that are coaxial with the excitation light L0. The first light L1 and the second light L2 have the same wavelength. Each of the excitation light L0, the first light L1, and the second light L2 is pulsed light. The laser light source 21 is not limited to a semiconductor laser. A solid-state laser may be used.

The nonlinear optical crystal 22 may be a type-II nonlinear optical crystal, and emit the first light L1 and the second light L2 that are non-coaxial with the excitation light L0. The first light, L1, and the second light, L2, may have different wavelengths. In this case, the first light L1 and the second light L2 are in a non-degenerate state and have wavelengths different from the wavelength in a degenerate state. For example, the first light L1 may be visible light, and the second light L2 may be infrared light.

In any one of the examples, the energy conservation law and the phase matching condition represented by the first mathematical formulae (first equation and second equation) using the Dirac constant are satisfied, respectively.

$$\begin{matrix}First Mathematical Formulae & \\ {ℏω}_{p} = {ℏω}_{s} + {ℏω}_{i} & First Equation\end{matrix}$$

$$ℏ {\vec{k}}_{p} = ℏ {\vec{k}}_{s} + ℏ {\vec{k}}_{i} \qquad Second Equation$$

In the first equation, ωₚ, ωₛ, and ωᵢ are the angular frequencies of the excitation light, the signal light, and the idler light, respectively. In the second equation, the vectors of kₚ, kₛ, and kᵢ are the wave vectors of the excitation light, the signal light, and the idler light, respectively. For example, when the excitation light having a wavelength of 355 nanometers (nm) is used, a quantum entangled photon pair of degenerate signal light and idler light having a wavelength of 710 nm can be generated. Further, signal light and idler light having different wavelengths can be generated while satisfying the energy conservation law and the phase-matching condition. For example, signal light having a wavelength of 1000 nm and idler light having a wavelength of 667 nm can be generated from excitation light having a wavelength of 400 nm.

The light emitter 200 may not include the nonlinear optical crystal 22 and may include a semiconductor element that can generate a photon pair in a quantum entangled state (quantum entangled photon pair). Examples of the semiconductor element that can generate the quantum entangled photon pair include a semiconductor element including a quantum dot and a semiconductor element including a waveguide structure.

The controller 300 controls the light emitting and receiving device 100 to turn on and off the light emitter 200 and the light receiver 400. The control instruction to the controller 300 may be given based on an operational input to the light emitting and receiving device 100, or may be given by sending a signal from an external device to the controller 300 based on an operational input to the external device. The external device is, for example, a personal computer connected to the light emitting and receiving device 100 through wire or wireless. The controller 300 includes an electric circuit and a processor.

As illustrated in FIG. 2, the controller 300 includes the light-emission controller 31 and the input-output unit 32. The functions of the light-emission controller 31 and the input-output unit 32 are implemented by an electric circuit and the processor.

The light-emission controller 31 gives the timing of emitting the excitation light L0 to the nonlinear optical crystal 22 with respect to the laser light source 21 and gives the timing of projecting light to the light emitter 200. The light-emission controller 31 gives information on the number of repetition times of light projection and the timing of light projection to the light emitter 200. The light emitter 200 projects the first light L1 and the second light L2 to the object S based on the information indicated by the light-emission controller 31.

Since the input-output unit 32 controls communication with the control target such as the light emitter 200, the input-output unit 32 can transmit and receive various information between the input-output unit 32 and the control target.

In FIG. 1, the light receiver 400 includes a first light receiver 401. The first light receiver 401 may be, for example, a high-sensitivity image sensor including a single photon avalanche diode (SPAD) as a quantum entanglement light receiving unit. The light receiver 400 may include an area sensor in which pixels are arrayed in two dimensions or a line sensor in which pixels are arrayed in one dimension.

At least one of the first light L1 or the second light L2 emitted from the light emitter 200 is reflected by the object S as first reflected light R1. The reflection by the object S includes specular reflection, diffuse reflection, and scattering. The first light receiver 401 receives the first reflected light R1 at the single photon level, acquires multiple frames in time series, and outputs a first received light image Im1 captured by the multiple frames. The analyzer that has received the first received light image Im1 from the light receiver 400 can acquire measurement information such as distance information by a calculation based on the first received light image Im1.

A quantum entangled photon pair, classical light that is not in a quantum entangled state, and environmental light that is not used for distance measurement can enter the light receiver 400. A simultaneous (i.e., coincidence) measurement can be used to detect a quantum entangled photon pair among these photons. The simultaneous measurement is a method of counting a detection of the quantum entangled photon pair only when an event in which a first detection unit detects a photon and an event in which a second detection unit detects a photon coincide with each other. For example, when the first light L1 and the second light L2 follow substantially the same optical path, it is considered that the first light L1 and the second light L2 enter the first light receiver 401 at substantially the same time. The analyzer processes the first received light image Im1 from the first light receiver 401 and can acquire quantum correlation information. The quantum correlation information refers to information on correlations that can arise due to the presence of a quantum entangled state. The analyzer that can acquire, for example, an image including quantum correlation information as the quantum correlation information.

The light emitting and receiving device 100 may include an irradiation unit including an optical element such as a lens, a diffractive optical element, or a diffusion plate, and a scanning mirror. The irradiation unit irradiates the object S with the divergent light generated by the lens from the light projecting-and-receiving device 100. When the irradiation unit includes a lens that diverges the first light L1 and the second light L2, the surrounding space can be illuminated at once by the collective illumination method. The irradiation unit may be an optical scanner including a scanning mirror. The irradiation unit includes a scanning mirror rotatable around a rotation axis of the scanning mirror. The scanning mirror scans the object S with the first light L1 and the second light L2 emitted from the light emitter 200 and, the object S is irradiated with the first light L1 and the second light L2. When the irradiation unit includes a scanning mirror, a portion of the illumination region can be mechanically moved with a scanning illumination method that scans the portion of the region with projection light having a narrow angle.

The light emitting and receiving device 100 may further include a receiving light guide including an optical element such as a lens or a diffractive optical element, and a scanning mirror that guides the first reflection light R1 to the first light receiver 401.

### Operation and Effect of Light Projecting-and-Receiving Apparatus

As described above, in the present embodiment, the light emitting and receiving device 100 projects a photon pair including the first light L1 and the second light L2 in a state of quantum entanglement with each other, and outputs a first received light image Im1 obtained by receiving the first reflected light R1 of the projected photon pair from the object S. Since the analyzer acquires measurement information such as distance information based on the first received light image Im1, measurement with high robustness against disturbance light can be achieved.

### Modification of First Embodiment

A modification of the first embodiment will be described below. In the following description, common or corresponding elements are denoted by the same or similar reference signs, and redundant description is appropriately simplified or omitted. This point is also applied to other modifications and embodiments described below.

The present modification differs from the first embodiment mainly in that the first light L1 is emitted to the outside, the second light L2 is emitted to the optical path guided to the light receiver 400, and only the first light L1 of the first light L1 and the second light L2 is reflected by the object S as the first reflected light R1.

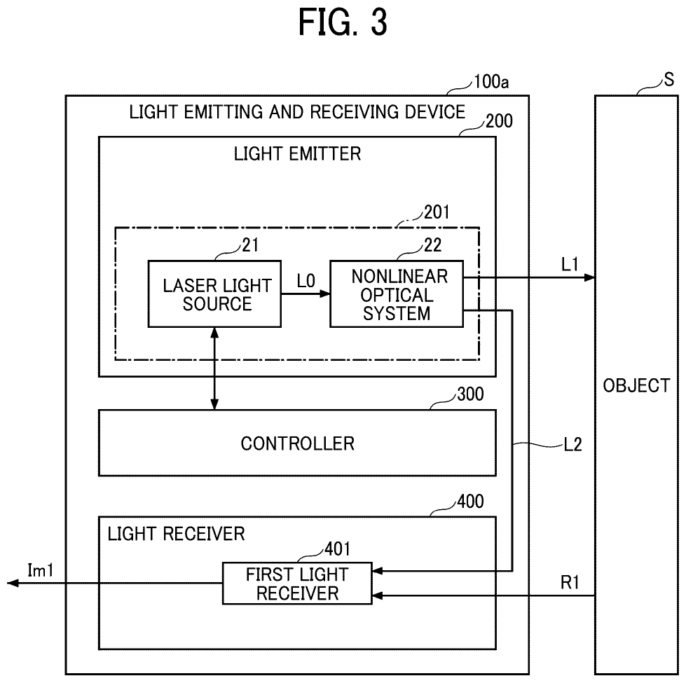

FIG. 3 is a diagram illustrating an example of a configuration of a functional block of a light emitting and receiving device 100a according to the present modification. As illustrated in FIG. 3, in the light emitting and receiving device 100a, only the first light L1 of the first light L1 and the second light L2 emitted from the first light emitter 201 is projected to the outside, and the second light L2 is guided to the first light receiver 401 without passing through the outside and received by the first light receiver 401. The first light receiver 401 may include a first detector that receives the first light L1 and a second detector that receives the second light L2.

In the present modification, the first light receiver 401 has different light receiving timings between the first light L1 and the second light L2 depending on the optical path differences between the first light L1 and the second light L2. In the present embodiment, the quantum correlation information can be obtained based on the first light L1 and the second light L2 also in this case. In the present embodiment, since the second light L2 that does not pass through the object S is used, the robustness against external light can be increased. The second light L2 may be projected to the outside, and the first light L1 may be guided to the first light receiver 401 without passing through the outside. Effects other than the above are the same as those of the first embodiment.

### Second Embodiment

A distance measuring system according to a second embodiment will be described below. The distance measuring system according to the present embodiment (i.e., present distance measuring system) differs from the distance measuring system according to the first embodiment mainly in that the present distance measuring system includes an analyzer that acquires distance information to an object by calculation based on a first received light image output from the light emitting and receiving device in addition to the light emitting and receiving device. The light emitting and receiving device in the present distance measuring system according to the second embodiment differs from the light projecting-and-projecting apparatus according to the first embodiment mainly in that the light emitting and receiving device includes a second light emitting unit that emits third light, which is classical light, the third light is reflected by the object S as second reflected light, and the light receiver receives the first reflected light and the second reflected light.

### Configuration Example of Distance Measurement System According to Second Embodiment

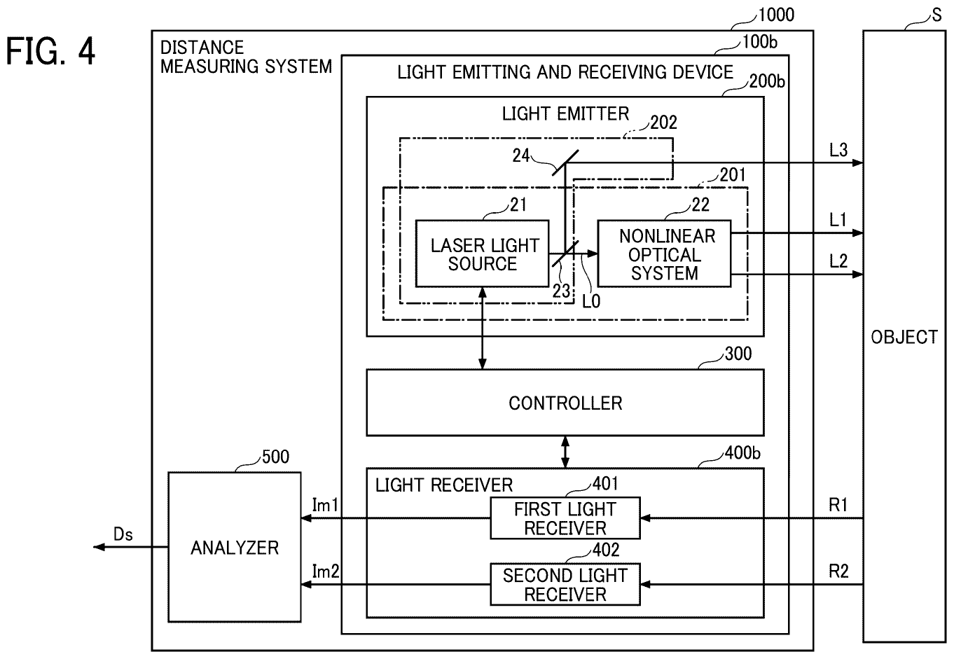

FIG. 4 is a block diagram illustrating an example of a configuration of the distance measuring system according to the second embodiment of the present disclosure. As illustrated in FIG. 4, the distance measuring system 1000 according to the second embodiment includes a light emitting and receiving device 100b and an analyzer 500. Further, the light emitting and receiving device 100b includes a light emitter 200b, a controller 300, and a light receiver 400b. The light emitter 200b includes a second light emitter 202 in addition to the first light emitter 201.

The second light emitter 202 emits third light L3 of classical light. The second light emitter 202 includes a laser light source 21, a beam splitter 23, and a reflection mirror 24. The laser light source 21 is shared by the first light emitter 201 and the second light emitter 202. The beam splitter 23 splits a portion of the light emitted from the laser light source 21 and transmits the remaining portion of the light. The light transmitted through the beam splitter 23 enters the nonlinear optical crystal 22 as excitation light L0. The light reflected from the beam splitter 23 is reflected by the reflection mirror 24 and projected to the outside as third light L3. The third light L3 projected to the outside is reflected by the object S as the second reflection light R2.

In addition to the first light receiver 401, the light receiver 400b further includes a second light receiver 402 to receive the light including the second reflection light R2. The first light receiver 401 may include a single photon detector that detects a single photon, and the second light receiver 402 may include a light amount detector that detects the amount of light by integrating the amount of received light over a predetermined period or a predetermined number of times. As the light amount detector, a photo diode (PD), an avalanche photo diode (APD), an SPAD, or an electron multiplying (EM)-charge coupled device (CCD) can be used. The EM-CCD is a CCD having an electron multiplication function. When a single-photon detector such as SPAD is used as a light amount detector, a light intensity image is generated by integrating the received light image.

The first light receiver Im1 outputs the first received light image Im1 to the analyzer 500. The second received light Im2 outputs the second received light image Im2 to the analyzer 500. Since the light receiver 400b includes the first light receiver 401 and the second light receiver 402, the first received light image Im1 derived from the light in the quantum entangled state with each other and the second received light image Im2 derived from the classical light can be acquired in parallel.

The analyzer 500 receives the first received light image Im1 from the first light receiver 401 and receives the second received light image Im2 from the second light receiver 402. The analyzer 500 outputs distance information D2 including at least one of the first distance information based on the first received light image Im1 or the second distance information based on the second received light image Im2.

### Hardware Configuration of Analyzer

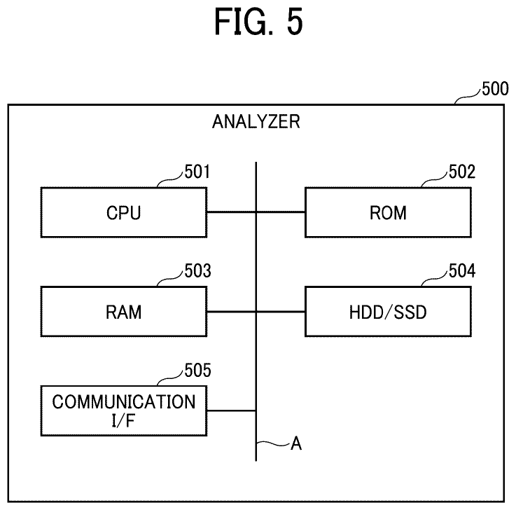

FIG. 5 is a block diagram illustrating an example of a hardware configuration of the analyzer 500 as an example. As illustrated in FIG. 5, the analyzer 500 includes a central processing unit (CPU) 501, a read-only memory (ROM) 502, a random-access memory (RAM) 503. Further, the analyzer 500 includes an a hard disk drive (HDD) 504 (or solid state driver (SDD)) and a communication interface (I/F) 505. These devices are connected to each other via a system bus A so as to communicate with each other.

The CPU 501 executes control processing including various arithmetic processing. The ROM 502 stores a program such as an initial program loader (IPL) to boot the CPU 501. The RAM 503 is used for a work area of the CPU 501. The HDD 504 (or SDD) stores information such as programs and various data.

The communication I/F 505 is an interface for the analyzer 500 to communicate with various external devices through wire or wireless. Examples of the external devices include the light emitter 200b and the light receiver 400b. The analyzer 500 can transmit signals to the light emitter 200b or the light receiver 400b via the communication I/F 505, and can receive signals and data from the light emitter 200b or the light receiver 400b. The communication I/F 505 can also communicate with an external device via a communication network. For example, the analyzer 500 can connect to the Internet via the communication I/F 505 and communicate with an external device via the Internet.

### Functional Configuration Example of Analyzer

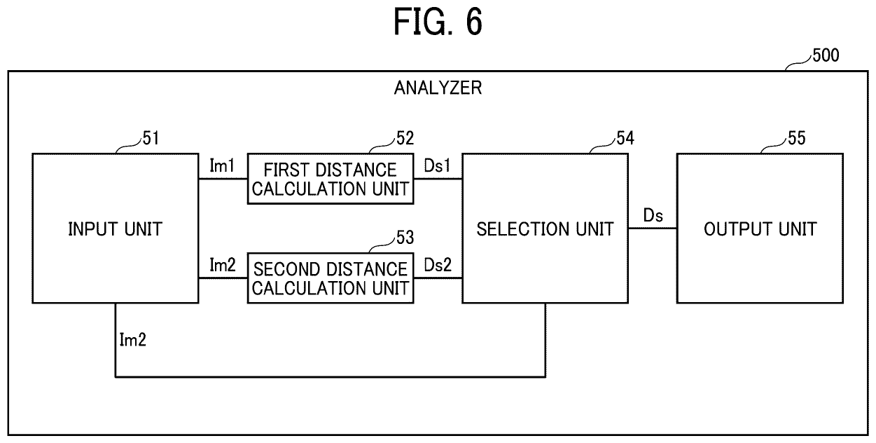

FIG. 6 is a block diagram illustrating an example of a functional configuration of the analyzer 500. The analyzer 500 includes an input unit 51, a first distance calculation unit 52, a second distance calculation unit 53, a selection unit 54, and an output unit 55. The functions of the input unit 51 and the output unit 55 are implemented by the communication I/F 505. The functions of the first distance calculation unit 52, the second distance calculation unit 53, and the selection unit 54 are implemented by a processor such as the CPU 501 that executes a process specified by a program stored in a nonvolatile memory such as the ROM 502.

Each function of the analyzer 500 is implemented by one or multiple processing circuits. The processing circuit includes a processor such as the CPU 501, and devices such as an application specific integrated circuit (ASIC), a digital signal processor (DSP), a field programmable gate array (FPGA), and a conventional circuit module designed to execute the above functions. A part of each function of the analyzer 500 may be implemented by distributed processing between the analyzer 500 and an external device.

The input unit 51 controls communication with the first light receiver 401 and receives the first received light image Im1 from the first light receiver 401, and controls communication with the second light receiver 402 and receives the second received light image Im2 from the second light receiver 402. The input unit 51 outputs the first received light image Im1 to the first distance calculation unit 52, outputs the second received light image Im2 to the second distance calculation unit 53, and outputs the second received light image Im2 to the selection unit 54.

The first distance calculation unit 52 calculates first distance information Ds1 to the object S based on the first light received image Im1 received via the input unit 51, and outputs the calculated first distance information Ds1 to the selection unit 54. For example, the first distance calculation unit 52 can specify an object frame among multiple frames in which the first received light image Im1 is captured, and calculate the first distance information Ds1 to the object S based on the flight time of light obtained from the specified object frame. The object frame is a frame in which reflected light from the object S is received, in other words, a frame in which the object S is detected.

The first distance calculation unit 52 can use, for example, a joint probability distribution (JPD) algorithm based on a joint probability distribution in order to specify an object frame. The JPD algorithm uses the correlation between multiple pixels in the same frame and the correlation between multiple pixels in adjacent frames in the time direction and is a calculation method that emerges quantum correlation information based on the multiple frames obtained in time series. For more information on the JPD algorithm, see, for example, Hugo Defienne et al., “PHYSICAL REVIEW A 103, 042608 (2021)”, 17, March 2021, Internet <URL: https://arxiv.org/pdf/2106.10689.pdfhttps://www.physics.gla.ac.uk/xtremelight/publications/P RA-SPADs-Hugo % 282021%29.pdf>, or Han Liu et al., “Enhancing LIDAR performance metrics using continuous-wave photon-pair sources”, 14, April 2020, Internet <https://arxiv.org/pdf/2004.06754.pdf>. However, the method of calculating the first distance information Ds1 based on the first received light image Im1 is not limited to the method using the JPD algorithm, and other calculation methods may be used.

The second distance calculation unit 53 calculates second distance information Ds2 to the object S based on the second light received image Im2 received via the input unit 51, and outputs the calculated second distance information Ds2 to the selection unit 54. The second distance calculation unit 53 can calculate the second distance information Ds2 by a time of flight (TOF) method based on the time difference between the projection of the third light L3 and the reception of the first reflected light R2.

The selection unit 54 selects at least one of the first distance information Ds1 or the second distance information Ds2 based on the received light amount in the second received light image Im2, and outputs the selection result to the output unit 55 as the distance information Ds. For example, the selection unit 54 selects the first distance information Ds1 when the received light amount is the first value, and selects the second distance information Ds2 when the received light amount is the second value that is greater than the first value. As the information of the received light, information such as an average value of the luminance of at least some pixels in the second received light image Im2, or a maximum value or a minimum value of the pixel in at least some pixels can be used.

The first value that is the threshold value of the received light amount can be determined in advance by experiments or simulations. For example, a distance that can obtain a distance measurement accuracy that is equal to or higher than a desired distance measurement accuracy can be determined by the first received light image Im1 using light in a quantum entangled state with each other, and the received light amount in the second received light image Im2 at this distance can be determined as the first value.

The output unit 55 controls the communication with the external device, and outputs the distance information Ds received from the selection unit 54 to an external device. The external device may be an electronic control unit (ECU) of an automobile that uses the result of the distance measurement by the distance measuring system 1000.

### Example of Processing Procedure by Analyzer

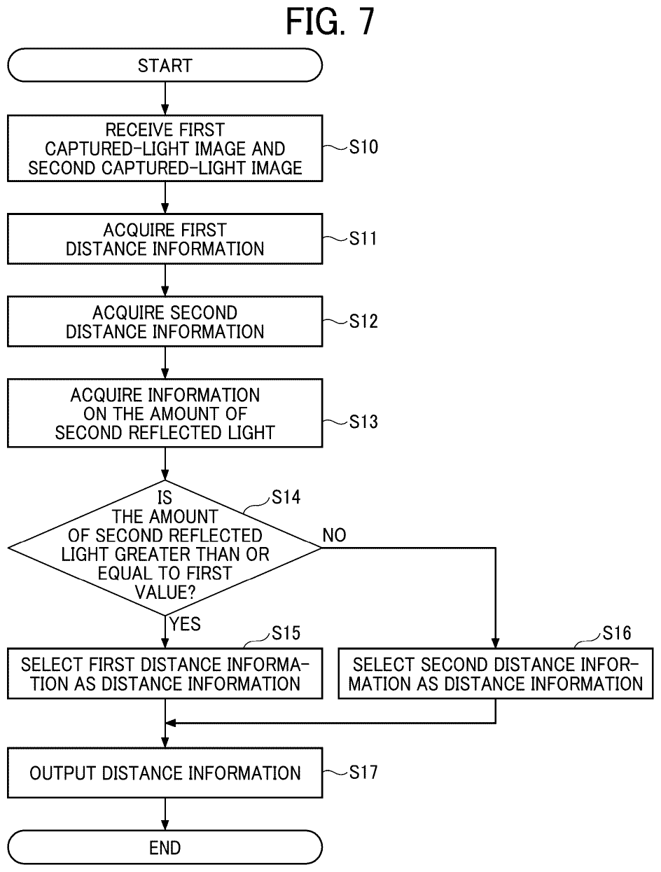

FIG. 7 is a flowchart of an example of processing performed by the analyzer 500 according to the second embodiment. In FIG. 7, the processing in which the analyzer 500 receives the first received image Im1 and the second received image Im2 from the light receiver 400b via the input unit 51 and outputs the distance information Ds is illustrated.

In step S11, the analyzer 500 obtains the first distance information Ds1 by calculation based on the first received light image Im1 by the first distance calculation unit 52.

In step S12, the analyzer 500 obtains the second distance information Ds2 by calculation based on the second received light image Im2 by the second distance calculation unit 53.

The order of steps S11 and S12 can be changed as appropriate, and steps S11 and S12 may be executed in parallel.

In step S13, the analyzer 500 acquires the received light amount of the second reflection light R2 based on the second received light image Im2 by the selection unit 54.

In step S14, the analyzer 500 determines whether the received light amount of the second reflection light R2 is equal to or smaller than the first value by the selection unit 54.

When it is determined that the received light amount of the second reflected light R2 is equal to or smaller than the first value in step S14 (YES in step S14), the analyzer 500 selects the first distance information Ds1 as the distance information Ds by the selection unit 54 in step S15.

When it is determined that the amount of received light of the second reflected light R2 is not equal to or smaller than the first value in step S14 (NO in step S14), the analyzer 500 selects the second distance information Ds2 as the distance information Ds by the selection unit 54 in step S16.

In step S17, the analyzer 500 outputs the distance information Ds to the external device by the output unit 55.

As described above, the analyzer 500 can receive the first received light image Im1 and the second received light image Im2 from the light emitting and receiving device 100b and output the distance image Ds.

### Operation and Effect of Light Projecting-and-Receiving Apparatus and Distance Measurement System

As described above, the light emitting and receiving device 100b according to the present embodiment includes the first light emitter 201 that emits the first light L1 and the second light L2 in a state of quantum entanglement with each other, the second light emitter 202 that emits the third light L3 as the classical light, and the light receiver 400b. At least one of the first light L1 or the second light L2 is reflected by the object S as the first reflected light R1, and the third light L3 is reflected by the object S as the second reflected light R2. The light receiver 400b receives the first reflected light R1 and the second reflected light R2.

Since the light emitting and receiving device 100b according to the present embodiment acquires measurement information such as distance information based on the first received light image Im1, a measurement with high robustness against outer disturbance light can be achieved. On the other hand, since each of the first light L1 and the second light L2 is weak light of a single photon level and attenuates while propagating a distance from the light emitting and receiving device 100b to the object S if the distance is long, the measurement range of the distance may be narrowed. By contrast, the light emitting and receiving device 100b acquires the second distance information Ds2 by the third light L3 in addition to the first distance information Ds1 obtained by the first light L1 and the second light L2. Since the amount of light of the third light L3 is larger than that of the first light L1 and the second light L2, the measurement range of the distance can be widened. As described above, in the present embodiment, the light emitting and receiving device 100b that can widen the measurable range and is robust against external light can be provided.

The distance measuring system 1000 according to the present embodiment includes the light emitting and receiving device 100b and the analyzer 500 that receives the first received light image Im1 from the first light receiver 401 and receives the second received light image Im2 from the second light receiver 402. The analyzer 500 outputs at least one of the first distance information Ds1 based on the first received light image Im1 or the second distance information Ds2 based on the second received light image Im2. The first distance information Ds1 based on the first received light image Im1 has high robustness against disturbance light since the first light L1 and the second light L2 are used. On the other hand, the second distance information Ds2 based on the second received light image Im2 can widen the measurement range since the third light L3 is used. Thus, in the present embodiment, the distance measuring system 1000 that can widen the measurement range and is robust against the external light can be provided.

The analyzer 500 may output at least one of the first distance information Ds1 or the second distance information Ds2 selected based on the received light amount of the second received light image Im2. For example, the analyzer 500 may output the first distance information Ds1 when the received light amount is the first value, and output the second distance information Ds2 when the received light amount is the second value that is greater than the first value. Accordingly, even in the case where a desired measurement accuracy cannot be obtained by setting the first distance information Ds1 to the distance information Ds when the distance to the object to be measured is long, the desired measurement accuracy can be obtained by setting the second distance information Ds2 to the distance information Ds.

In another aspect, the first received light image Im1 corresponds to first information including time-of-flight information on the first reflected light R1 generated by reflection of at least one of the first light L1 or the second light L2 in a quantum entangled state by the object S. The second received light image Im2 corresponds to second information including the time-of-flight information on the second reflected light R2 generated by the reflection of the third light L3 of the classical light by the object S. The analyzer 500 may output at least one of the first distance information Ds1 based on the first information or the second distance information Ds2 based on the second information. The analyzer 500 may output at least one of the first distance information Ds1 or the second distance information Ds2 selected based on the second information. The second information includes information on the received light amount of the second reflected light R2 by the light receiver 400b, and the analyzer 500 may output the first distance information Ds1 when the received light amount is the first value, and may output the second distance information Ds2 when the received light amount is the second value that is greater than the first value.

### Modification of Second Embodiment

A distance measuring system according to a modification of the second embodiment will be described below. The present modification differs from the second embodiment mainly in that the first light L1, the second light L2, and the third light L3 are separately extracted from the nonlinear optical crystal 22 in the light emitter.

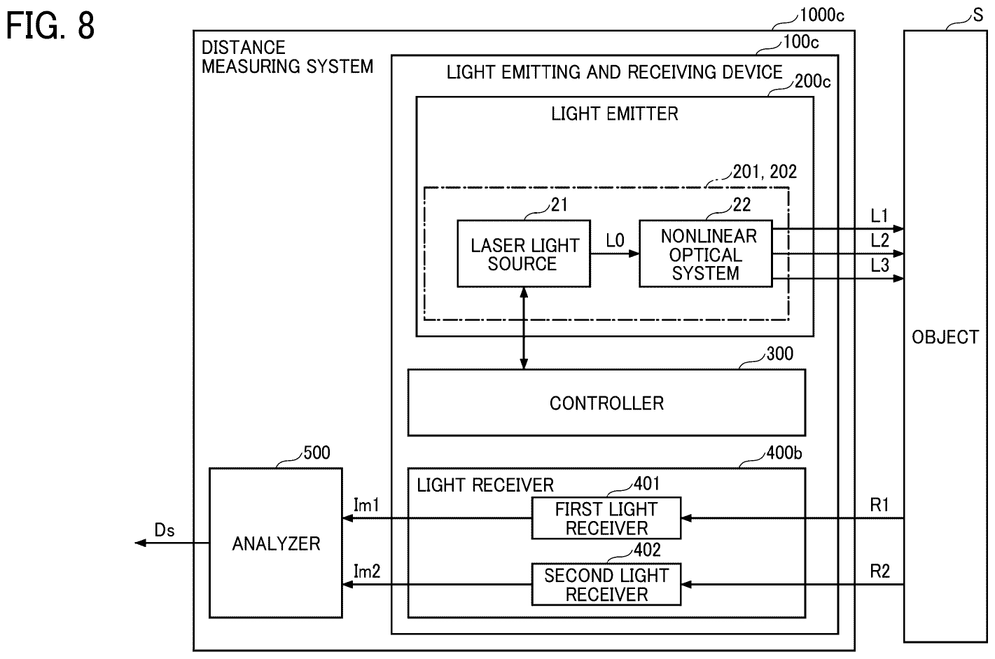

FIG. 8 is a block diagram illustrating an example of a configuration of a distance measuring system 1000c according to the present modification. The distance measuring system 1000c includes a light emitting and receiving device 100c. The light emitting and receiving device 100c includes a light emitter 200c.

The light emitter 200c causes the excitation light L0 from the laser light source 21 to enter the nonlinear optical crystal 22, and extracts the third light L3 that is the classical light from the nonlinear optical crystal 22 together with the first light L1 and the second light L2. For example, the light emitter 200c can extract the light that is the excitation light L0 transmitted through the nonlinear optical crystal 22 as the third light L3.

In the present modification, since the third light L3 is extracted without disposing the beam splitter 23 and the reflection mirror 24 (see FIG. 4) in the second embodiment, the size of the light emitter 200c can be reduced, and the alignment adjustment of the light emitter 200c can be simplified.

### Third Embodiment

A distance measuring system according to a third embodiment will be described below. The present embodiment differs from the second embodiment mainly in that the first light L1 is emitted to the outside, the second light L2 is emitted to the optical path that guides the second light L2 to the light receiver 400b, and only the first light L1 of the first light L1 and the second light L2 is reflected by the object S as the first reflected light R1.

### Configuration Example of Distance Measurement System According to Third Embodiment

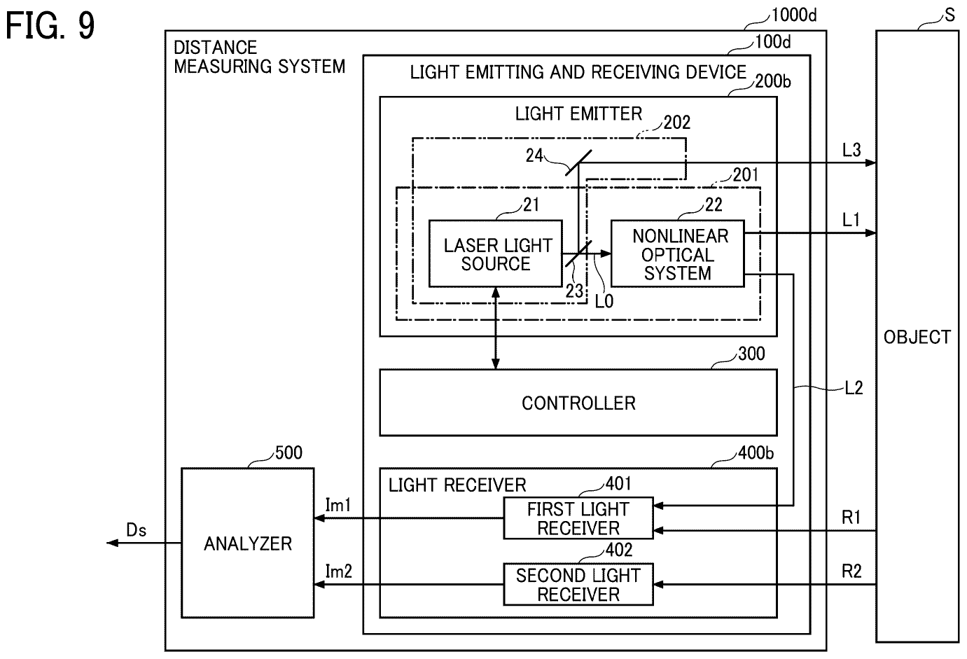

FIG. 9 is a block diagram illustrating an example of a configuration of a distance measuring system 1000d according to the third embodiment of the present disclosure. As illustrated in FIG. 9, only the first light L1 of the first light L1 and the second light L2 emitted from the first light emitter 201 is projected to the outside, and the second light L2 is guided to the first light receiver 401 without passing through the outside and is received by the first light receiver 401.

In the present embodiment, the first light receiver 401 has different light receiving timings of the first light L1 and the second light L2 depending on the optical path differences between the first light L1 and the second light L2. In the present embodiment, the quantum correlation information can be obtained based on the first light L1 and the second light L2 also in this case. In the present embodiment, since the second light L2 that does not pass through the object S is used, the robustness against external light can be increased. The second light L2 may be projected to the outside, and the first light L1 may be guided to the first light receiver 401 without passing through the outside. Effects other than the above are the same as those of the second embodiment.

### Modification of Third Embodiment

A distance measuring system according to a modification of the third embodiment will be described below. The present modification differs from the third embodiment mainly in that the first light L1, the second light L2, and the third light L3 are separately extracted from the nonlinear optical crystal 22 in the light emitter.

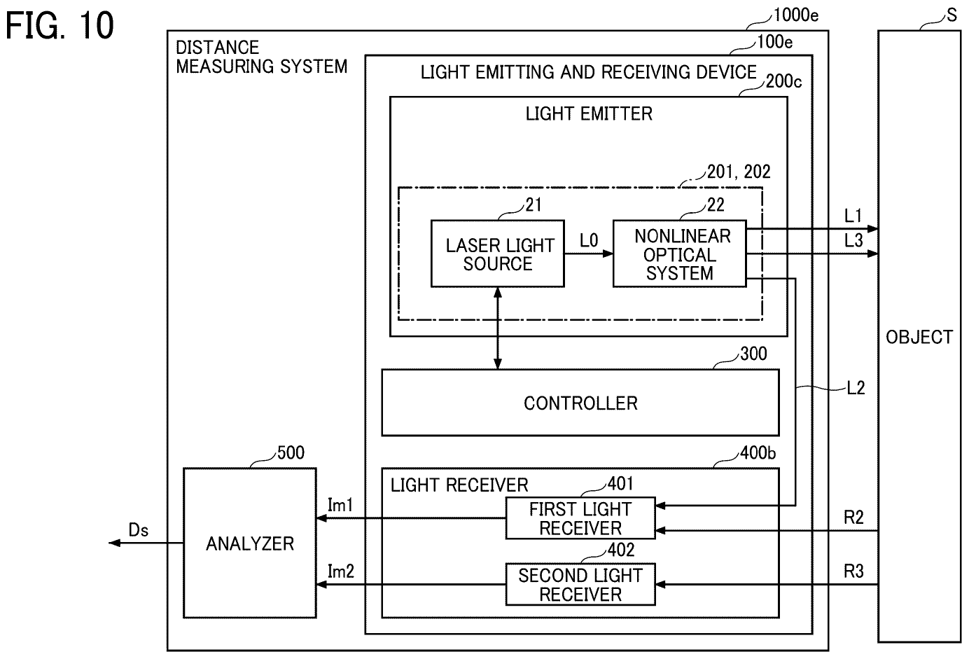

FIG. 10 is a block diagram illustrating an example of a configuration of a distance measuring system 1000c according to the present modification. The distance measuring system 1000e includes a light emitting and receiving device 100e. The light emitting and receiving device 100e includes a light emitter 200c.

The light emitter 200c causes the excitation light L0 from the laser light source 21 to enter the nonlinear optical crystal 22, and extracts the third light L3 that is the classical light from the nonlinear optical crystal 22 together with the first light L1 and the second light L2. For example, the light emitter 200c can extract the light that is the excitation light L0 transmitted through the nonlinear optical crystal 22 as the third light L3.

In the present modification, since the third light L3 is extracted without disposing the beam splitter 23 and the reflection mirror 24 (see FIG. 9) in the third embodiment, the size of the light emitter 200c can be reduced, and the alignment adjustment of the light emitter 200c can be simplified.

### Fourth Embodiment

A distance measuring system according to a fourth embodiment will be described below. The present embodiment differs from the above-described embodiments and modifications mainly in that the analyzer disposed in the distance measuring system according to the fourth embodiment includes an inference unit that inputs the quantum correlation information acquired by the first light and the second light in a state of quantum entanglement with each other, infers the information based on the quantum correlation information, and outputs the result of inference.

### Configuration Example of Distance Measurement System According to Fourth Embodiment

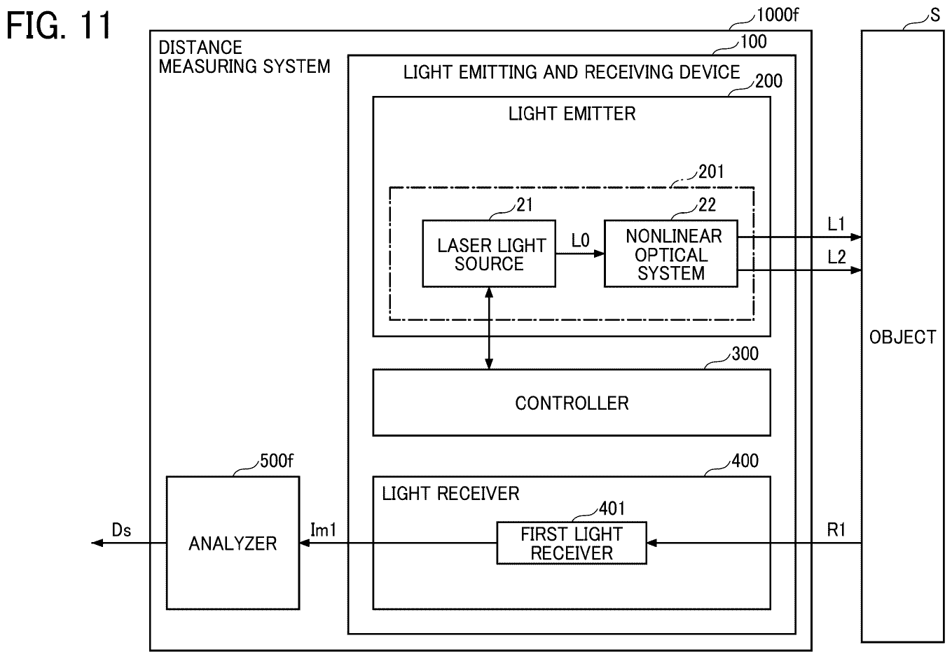

FIG. 11 is a block diagram illustrating an example of a configuration of a distance measuring system 1000f according to the fourth embodiment. As illustrated in FIG. 11, the distance measuring system 1000f includes an analyzer 500f.

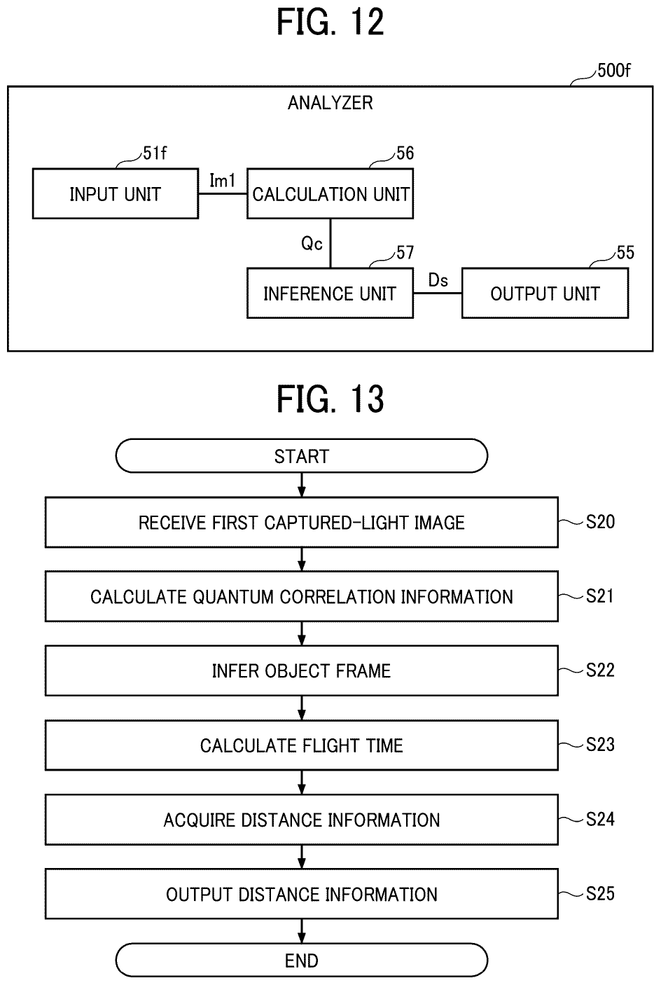

FIG. 12 is a block diagram illustrating an example of a functional configuration of the analyzer 500f. The analyzer 500f includes an input unit 51f, a calculation unit 56, and inference unit 57. The function of the input unit 51f is implemented by the communication I/F 505 in FIG. 5. The functions of the calculation unit 56 and the inference unit 57 are implemented by a processor such as the CPU 501 (FIG. 5) that executes a process specified by a program stored in a nonvolatile memory such as the ROM 502.

The input unit 51 controls communication with the first light receiver 401, receives the first received light image Im1 as the received light image from the first light receiver 401, and outputs the received first received light image Im1 to the inference unit 57. The first received light image Im1 is obtained by the first light receiver 401 that receives light including the first reflected light R1 generated by reflecting at least one of the first light L1 or the second light L2 by the object S.

The calculation unit 56 calculates quantum correlation information Qc (coincidence image) using the JPD algorithm based on the input first received light image Im1. The quantum correlation information Qc may be multiple spatially correlated images acquired by the first light L1 and the second light L2 at different times. The quantum correlation information Qc is output to the inference unit 57.

The inference unit 57 receives the quantum correlation information from the calculation unit 56, infers an object frame based on the quantum correlation information, and outputs the result of inference. The inference unit 57 may output information relating to the object frame that is a frame in which the object S is detected as the result of inference.

The inference unit 57 includes artificial intelligence (AI: Inference can be performed by artificial intelligence. The inference unit 57 includes a learned model that has been machine-learned in advance by a learning apparatus. The learning apparatus can generate a learned model using, for example, the quantum correlation information Qc. The inference unit 57 may presume the object frame based on the quantum correlation information Qc and the learned model. The learning apparatus may learn based on the first received light image Im1 (illumination image) in addition to the quantum correlation information Qc, and the inference unit 57 may presume the object frame based on the quantum correlation information Qc, the first received light image Im1, and the learned model. Accordingly, the accuracy of the inference can be increased.

The inference unit 57 can calculate the flight time of the light based on the presumed object frame, and can calculate the distance information Ds to the object S according to the flight time. There are various methods of machine learning in the learning apparatus, such as reinforcement learning, semi-supervised learning, and unsupervised learning. There is no limitation on the method of machine learning, if the learning which handles the image can be executed. In terms of enabling complex inference, it is preferable that the method is based on deep learning.

### Example of Processing Procedure by Analyzer

FIG. 13 is a flowchart of an example of processing performed by the analyzer 500f. In FIG. 13, the processing in which the analyzer 500f receives the first received light image Im1 from the light receiver 400b via the input unit 51 and outputs the distance information Ds is illustrated.

In step S21, the analyzer 500f calculates the quantum correlation information Qc based on the first received light image Im1 by the calculation unit 56.

In step S22, the analyzer 500f infers the object frame based on the quantum correlation information Qc received from the calculation unit 56 and the learning model by the inference unit 57.

In step S23, the analyzer 500f calculates the flight time of the light based on the presumed object frame by the inference unit 57.

In step S24, the analyzer 500f obtains the distance information Ds to the object S from the calculated flight time by calculation using the inference unit 57.

In step S25, the analyzer 500f outputs the distance information Ds calculated by the inference unit 57 to the external device by the output unit 55.

As described above, the analyzer 500f can receive the first received light image Im1 from the light emitting and receiving device 100b and output the distance image Ds.

### Operation and Effect of Distance Measuring System

As described above, in the present embodiment, the analyzer 500f includes the inference unit 57 that inputs the quantum correlation information Qc acquired by the first light L1 and the second light L2 in the quantum entangled state, infers the object frame based on the quantum correlation information Qc, and outputs the result of inference. The quantum correlation information Qc may be multiple spatially correlated images acquired by the first light L1 and the second light L2 at different times. The analyzer 500f may include a calculation unit 56 to which the first received light image Im1 (received light image) is input. The first received light image Im1 may be obtained by receiving light including the first reflected light R1 generated by reflecting at least one of the first light L1 or the second light L2 by the object S, and the quantum correlation information Qc may be calculated by the calculation unit 56 and output to the inference unit 57. As described above, the present embodiment can provide the distance measuring system 1000f that can perform inference based on light in a quantum entangled state.

The inference unit 57 may output information relating to an object frame that is a frame in which the object S is detected as the result of inference. The analyzer 500f can specify the object frame robustly against the external light by the inference unit 57. In the present embodiment, since the information on the object frame specified by the inference unit 57 is used, the distance measuring system 1000f that is strong against external light can be provided.

In another aspect, the distance measuring system 1000f may include an analyzer 500f that inputs first information (first received light image Im1) including flight time information on the first reflected light R1 generated by reflection of at least one of the first light L1 or the second light L2 in a quantum entangled state by the object S and outputs an analysis result. The analysis result may include at least one of information on an object frame that is the frame in which the object S is detected, information on flight time to the object S, or information on the distance to the object S. The analyzer 500f may include the inference unit 57 that infers the object frame based on the quantum correlation information calculated from the first information.

### Fifth Embodiment

A distance measuring system according to a fifth embodiment will be described below. The present embodiment differs from the fourth embodiment mainly in that the distance measuring system includes a controller that controls the first light emitter and the light receiver, and the analyzer calculates the driving conditions of the first light emitter and the light receiver based on the analysis result by the analyzer and outputs a driving signal to the controller.

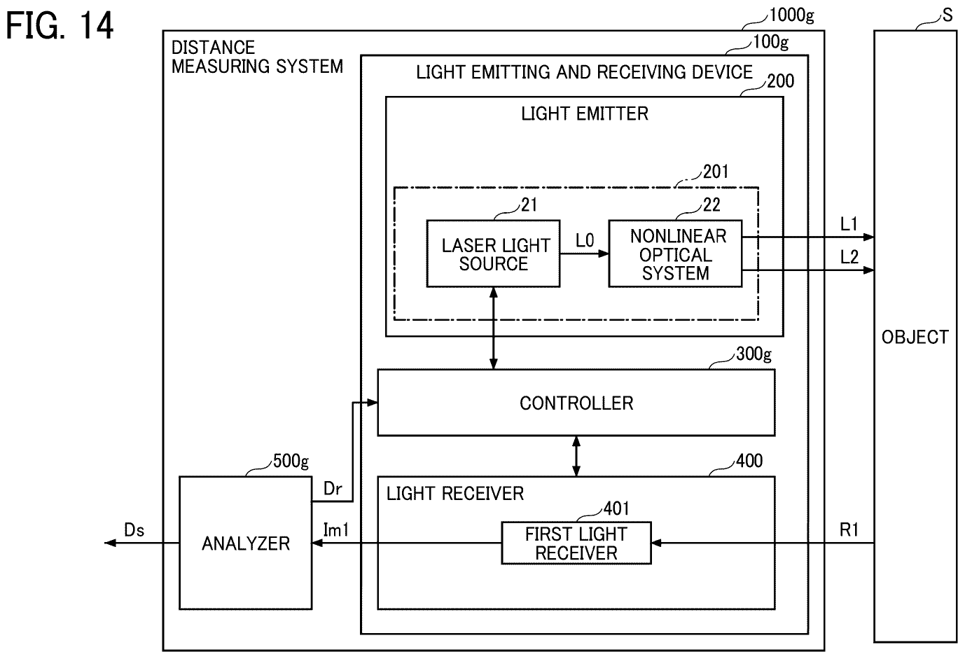

FIG. 14 is a block diagram illustrating an example of a configuration of a distance measuring system 1000g according to the fifth embodiment. The distance measuring system 1000g includes a light emitting and receiving device 100g and an analyzer 500g.

The light emitting and receiving device 100g includes a controller 300g.

The analyzer 500g calculates the driving conditions of the first light emitter 201 and the light receiver 400 based on the analysis result by the analyzer, and outputs the driving signal Dr to the controller 300g. For example, the analyzer 500g calculates the number of frames that captures the first received light image Im1 obtained by receiving the light including the first reflected light R1 as the driving condition. The controller 300g can control the first light emitter 201 and the light receiver 400 depending on the drive signal Dr from the analyzer 500g.

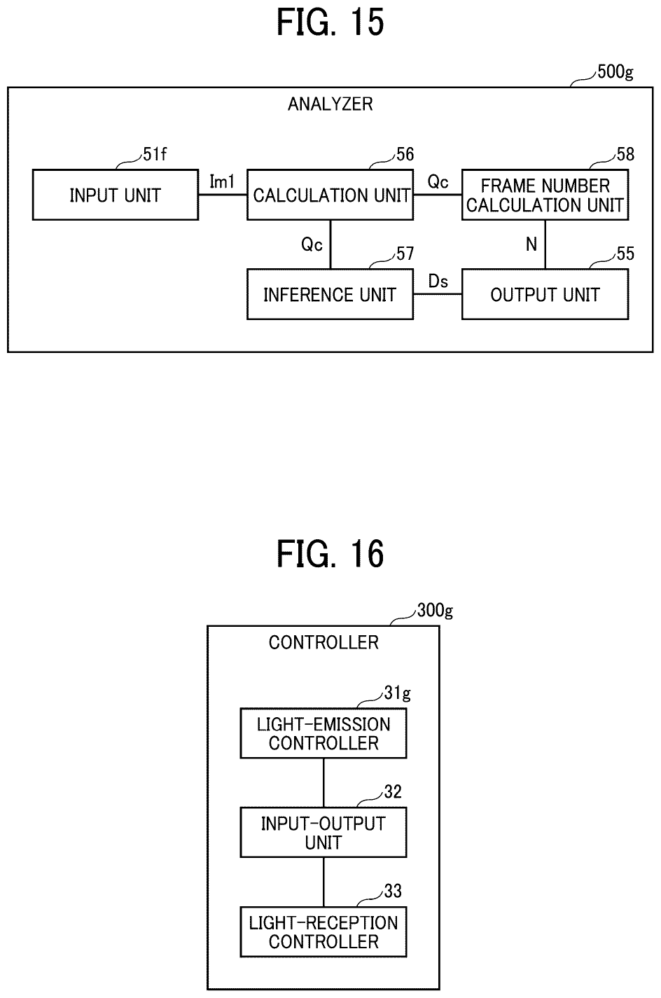

FIG. 15 is a block diagram illustrating an example of a functional configuration of the analyzer 500g. The analyzer 500g includes a frame number calculation unit 58. The functions of the frame number calculation unit 58 and the inference unit 57 are implemented by a processor such as the CPU 501 (FIG. 5) that executes a process specified by a program stored in a nonvolatile memory such as the ROM 502.

The frame number calculation unit 58 calculates the number of frames N that captures the first received light image Im1 based on the quantum correlation information Qc calculated by the calculation unit 56. The number of frames N calculated by the frame number calculation unit 58 corresponds to, for example, the number of frames N used in the calculation of the joint probability distribution of the JPD algorithm described above. The number of frames N corresponds to the driving conditions of the first light emitter 201 and the light receiver 400.

The drive signal Dr (see FIG. 14) corresponding to the number of frames N calculated by the frame number calculation unit 58 is output to the controller 300g via the output unit 55.

FIG. 16 is a block diagram illustrating an example of a functional configuration of the controller 300g. The controller 300g includes a light-reception control unit 31g and a light-reception control unit 33. The functions of the light-reception control unit 31g and the light-reception control unit 33 are implemented by an electric circuit or a processor.

The light-reception control unit 31g gives the timing of light emission to the laser light source 21 depending on the drive signal Dr from the analyzer 500g. For example, as the number of frames N increases, the time interval at which the laser light source 21 emits the pulsed light depending on the drive signal Dr increases.

The light-reception control unit 33 sets the number of frames N that captures the first received light image Im1 for the first light receiver 401 depending on the drive signal Dr from the analyzer 500g. The first light receiver 401 can capture the first received light image Im1 by the set number of frames N.

The controller 300g may include a part of the functions of the analyzer 500g, or the analyzer 500g may include a part of the functions of the controller 300g. A part of the functions of the analyzer 500g or a part of the functions of the controller 300g may be implemented by the distributed processing of the analyzer 500g and the controller 300g.

### Operation Example of Distance Measurement System

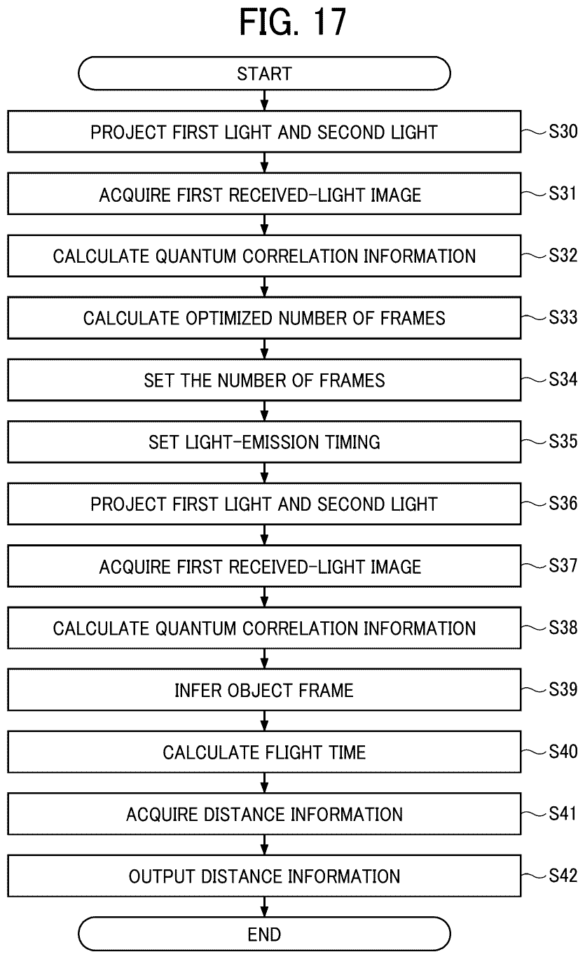

FIG. 17 is a flowchart of an example of the operation of the distance measuring system 1000g. In the operation of the distance measuring system 1000g illustrated in FIG. 17, the distance measuring system 1000g calculates the appropriate number of frames based on the first received light image Im1 obtained by projecting the first light L1 and the second light L2, and outputs the distance information on the distance to the object S obtained by projecting the first light L1 and the second light L2 again depending on the appropriate number of frames. The distance measuring system 1000g starts the operation in FIG. 17 by the projection of the first light L1 and the second light L2 as a trigger.

In step S31, the distance measuring system 1000g acquires a first received light image Im1 by the first light receiver 401.

In step S32, the distance measuring system 1000g calculates the quantum correlation information Qc by the analyzer 500g.

In step S33, the distance measuring system 1000g calculates the number of frames N optimized based on the quantum correlation information Qc by the analyzer 500g. The distance measuring system 1000g may set a criterion that determines whether the number of frames is appropriate in advance, and may repeat the operations from the projection of the first light L1 and the second light L2 to step S33 until the criterion is satisfied. The distance measuring system 1000g outputs the drive signal Dr depending on the calculated number of frames N to the controller 300g by the analyzer 500g.

In step S34, the controller 300g of the distance measuring system 1000g sets the number of frames that captures the first received light image Im1 in the first light receiver 401 depending on the drive signal Dr.

In step S35, the distance measuring system 1000g causes the controller 300g to give the timing of light emission depending on the drive signal Dr to the laser light source 21.

In step S36, the distance measuring system 1000g projects the first light L1 and the second light L2 depending on the timing of light emission given from the controller 300g.

In step S37, the distance measuring system 1000g acquires the first received light image Im1 by the first light receiver 401.

In step S38, the distance measuring system 1000g calculates the quantum correlation information Qc based on the first received light image Im1 by the analyzer 500g.

In step S39, the distance measuring system 1000g infers an object frame based on the quantum correlation information Qc and the learning model by the analyzer 500g.

In step S40, the distance measuring system 1000g calculates the flight time of the light based on the presumed object frame by the analyzed 500g.

In step S41, the distance measuring system 1000g obtains the distance information Ds to the object S from the calculated flight time by the analyzer 500.

In step S42, the distance measuring system 1000g outputs the distance information Ds to the external device by the analyzer 500g.

As described above, the distance measuring system 1000g can optimize the number of frames N that captures the first received light image Im1 and output the distance information Ds obtained depending on the optimized number of frames N.

### Operation and Effect of Distance Measurement System

As described above, in the present embodiment, the analyzer 500g calculates the driving condition of the first light emitter 201 and the light receiver 400 based on the analysis result by the analyzer 500g and outputs the drive signal Dr to the controller 300g. For example, the analyzer 500g may calculate, as the driving condition, the number of frames N that captures the first received light image Im1 obtained by receiving the light including the first reflected light R1. Since the distance measuring system 1000g calculates the appropriate number of frames N by the frame number calculation unit 58, the distance measuring system 1000g can prevent the measurement accuracy from decreasing when the number of frames N is small, and also prevent the distance measurement time from increasing when the number of frames N is large. Effects other than the above are the same as those of the fourth embodiment.

### Modification of Fifth Embodiment

A modification of the fifth embodiment will be described below. The present modification differs from the fifth embodiment mainly in that the inference unit infers the appropriate number of frames in addition to inferring object frames.

The configuration of a distance measuring system according to the present modification is different in that the inference unit 57 in FIG. 15 can presume the appropriate number of frames N. In this case, the analyzer 500g may not include the frame number calculation unit 58 illustrated in FIG. 15.

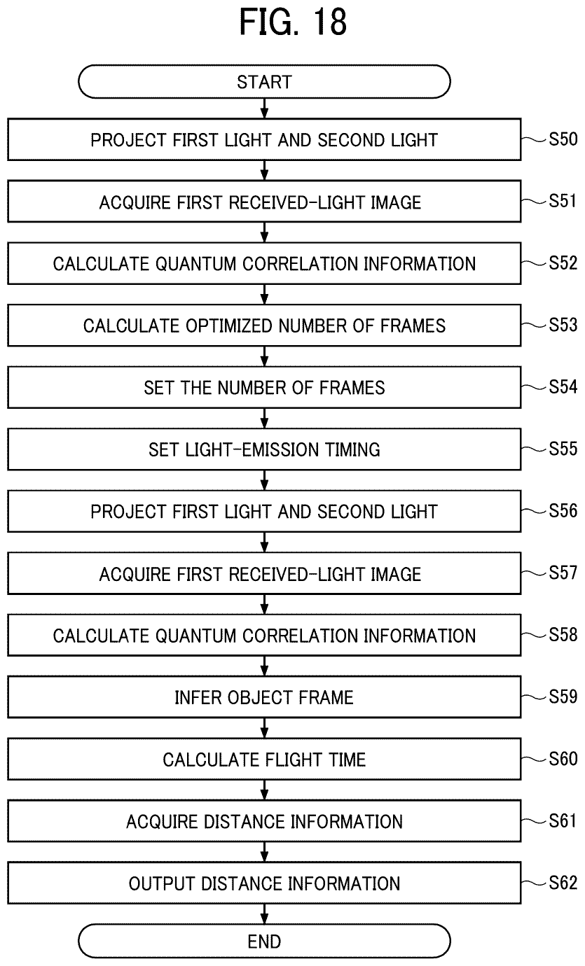

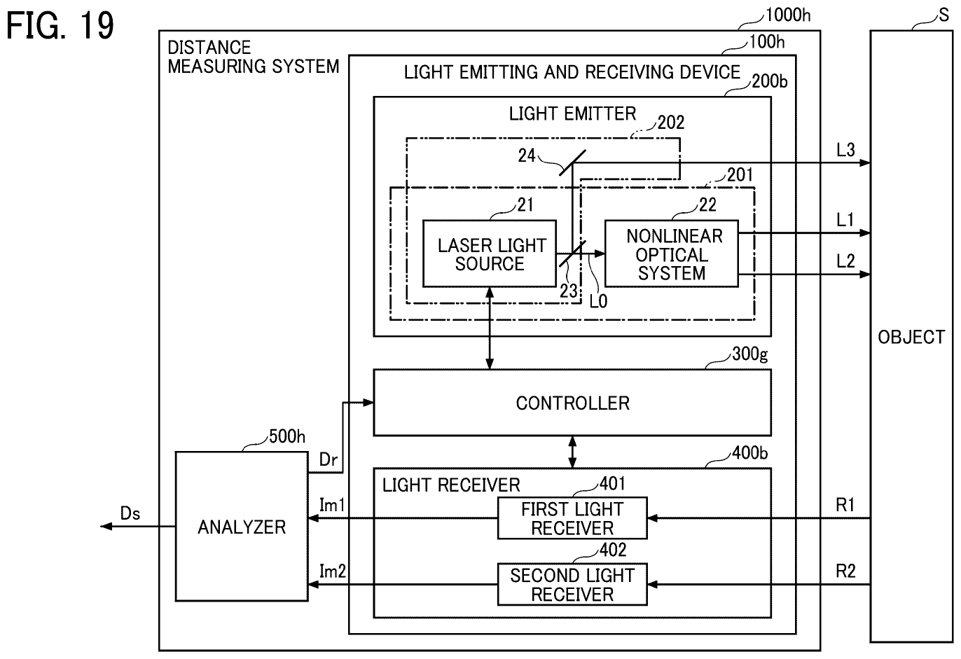

FIG. 18 is a flowchart of operation performed by the distance measuring system according to the present modification. In step S53 in FIG. 18, the distance measuring system according to the present modification differs from the distance measuring system 1000g illustrated in FIG. 17 in that the inference unit 57 of the analyzer 500g infers the appropriate number of frames N based on the quantum correlation information Qc. Since the operations of the other steps are substantially the same as those of the steps illustrated in FIG. 17, the redundant description is omitted here.

In the present modification, since the appropriate number of frames is presumed by the inference unit 57, the appropriate number of frames can be obtained even under various conditions.

### Sixth Embodiment

A distance measuring system according to a sixth embodiment will be described below. In the present embodiment, the light emitting and receiving device includes a second light emitter that emits the third light L3 of classical light. The light receiver 400b receives the first reflected light R1 and the second reflection light R2. The analyzer receives a second received light image Im2 by the second reflection light R2 and outputs the analysis result based on the first received light image Im1 and the second received light image Im2. The above points are different from those of the fifth embodiment.

### Configuration Example of Distance Measurement System According to Sixth Embodiment

FIG. 19 is a block diagram illustrating an example of a configuration of a distance measuring system 1000h according to the sixth embodiment. The distance measuring system 1000h differs from the distance measuring system 1000g according to the fifth embodiment in that the distance measuring system 1000h includes the light emitting and receiving device 100h and the analyzer 500h The light emitting and receiving device 100h includes a light emitter 200b.

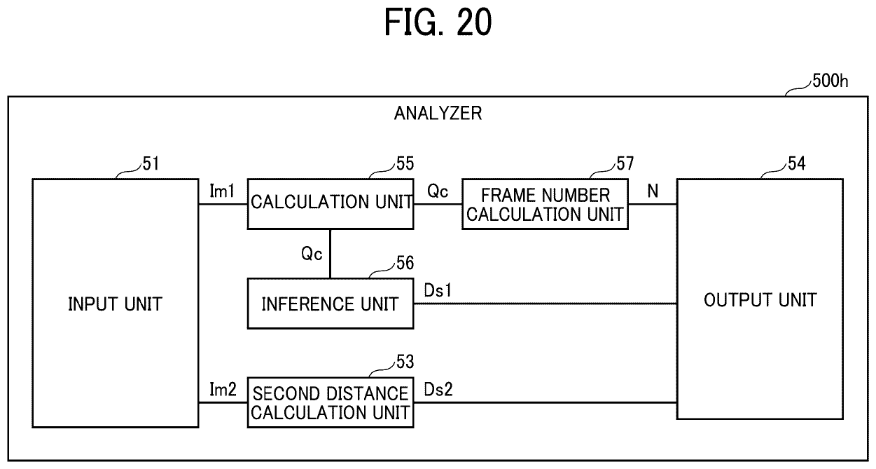

FIG. 20 is a block diagram illustrating an example of a functional configuration of the analyzer 500h. The analyzer 500h differs from the analyzer 500g according to the fifth embodiment in that the analyzer 500h includes a second distance calculation unit 53. The analyzer 500h can acquire the second distance information Ds2 based on the second received light image Im2 as the second information by the second distance calculation unit 53. The analyzer 500h can output at least one of the first distance information Ds1 or the second distance information Ds2 to the external device by the output unit 55.

### Operation Example of Distance Measuring System

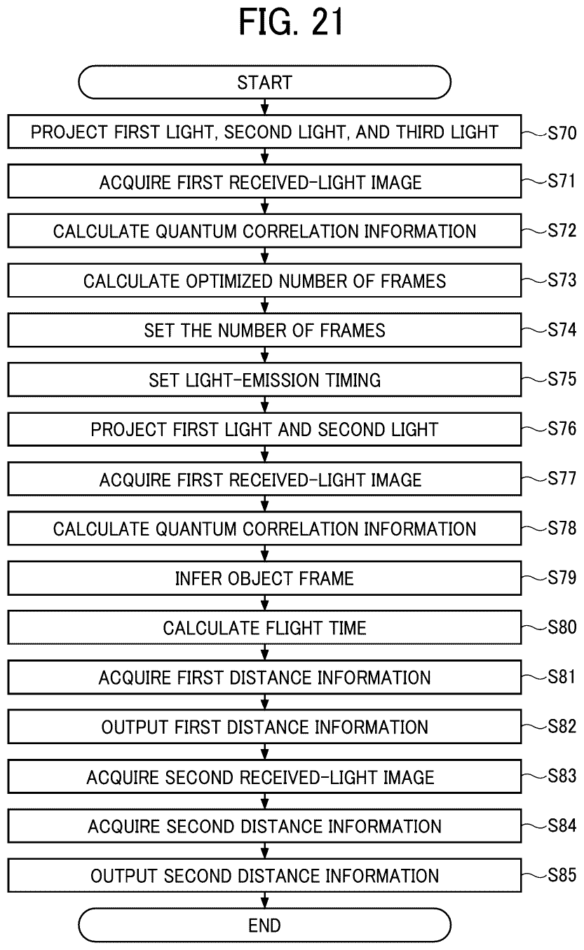

FIG. 21 is a flowchart of an example of the operation of the distance measuring system 1000h. The operations of steps S71 to S80 in FIG. 21 are substantially the same as those of steps S31 to S40 in FIG. 17, and thus, the redundant description is omitted.

In step S81, the distance measuring system 1000h acquires the first distance information Ds1 to the object S from the calculated flight time by calculation using the analyzer 500h.

In step S82, the distance measuring system 1000h outputs the distance information Ds1 to the external device by the analyzer 500h.

In step S83, the distance measuring system 1000h acquires the second received light image Im2 by the second light receiver 402.

In step S84, the distance measuring system 1000h acquires the second distance information Ds2 by the analyzer 500h.

In step S85, the distance measuring system 1000h outputs the second distance information Ds2 to the external device by the analyzer 500h.

As described above, the distance measuring system 1000h can output the second distance information Ds2 obtained by the third light L3 that is the classical light in addition to the first distance information Ds1 obtained by the first light L1 and the second light L2.

### Operation and Effect of Distance Measurement System

As described above, the distance measuring system 1000h acquires the second distance information Ds2 by the third light L3 in addition to the first distance information Ds1 obtained by the first light L1 and the second light L2.

Since the light amount of the third light L3 is larger than that of the first light L1 and the second light L2, the measurement range of the distance that can be measured can be widened. As described above, in the present embodiment, the distance measuring system 1000h that can widen the measurable range and is robust against the external light can be provided. Other effects are substantially the same as those of the fifth embodiment.

In another aspect, in the present embodiment, the second received light image Im2 (second information) including the flight time information of the second reflection light R2 generated by reflecting the third light L3 as the classical light by the object S may be further input to the analyzer 500h. The analyzer 500h may output the analysis result based on the first received light image Im1 (first information) and the second received light image Im2.

Although some embodiments have been described in detail, the present disclosure is not limited to the above-described embodiments, and various modifications and substitutions can be made to the above-described embodiments without departing from the scope of the claims.

All the numerals, such as ordinal numbers and numbers used in the description of the embodiments, are illustrative for specifically describing the technique of the present invention, and the present invention is not limited to the illustrated numerals. In addition, a connection relation between the components is an example for specifically describing the technology of the present disclosure, and a connection relation for implementing a function of the present disclosure is not limited thereto.

The division of blocks in the functional block diagram is an example, and multiple blocks may be implemented as one block, one block may be divided into multiple blocks, or some functions may be transferred to other blocks. Also, the functions of multiple blocks having similar functions may be processed in parallel or in a time-division manner by a single hardware or software. Alternatively, some or all of the functions may be distributed to multiple computers.

Aspects of the present disclosure are as follows, for example.

### Aspect 1

A distance measuring system includes: circuitry configured to: calculate quantum correlation information based on first light and second light quantum-entangled with the first light; perform inference based on the quantum correlation information to obtain inference results; and output the inference results.

### Aspect 2

In the distance measuring system according to Aspect 1, the quantum correlation information includes multiple spatially correlated images corresponding to the first light and the second light at different times.

### Aspect 3

In the distance measuring system according to Aspect 1, the circuitry is further configured to: infer an object frame corresponding to at least one of the first light or the second light reflected from an object, and the inference results include information on the object frame.

### Aspect 4

In the distance measuring system according to Aspect 1, the circuitry is further configured to receive a captured-light image of reflection light of at least one of the first light or the second light reflected from an object.

### Aspect 5

A distance measuring system includes circuitry configured to: receive information including flight time information based on reflection light of at least one of first light or second light reflected from the object, the first light and the second light being quantum-entangled with each other; and output analysis results including at least one of: object frame information about an object frame corresponding to the reflection light from the object; the flight time information; and distance information about a distance to the object.

### Aspect 6

In the distance measuring system according to Aspect 5, the circuitry is further configured to: calculate quantum correlation information based on the information including the flight time information; and perform inference based on the quantum correlation information to obtain inference results.

### Aspect 7

In the distance measuring system according to Aspect 5, the circuitry is further configured to: receive another information including flight time information based on another reflection light of third light of classical light reflected from the object; and output the analysis results based on the information and said another information.

### Aspect 8

The distance measuring system according to claim 5, further includes: a light emitter to emit the first light and the second light; a light receiver to receive the reflection light; and another circuitry configured to control the light emitter and the light receiver. The circuitry is further configured to calculate driving conditions for the light emitter and the light receiver, based on the analysis results; and output a driving signal corresponding to the driving conditions, to said another circuitry.

### Aspect 9

In the distance measuring system according to Aspect 8, the driving conditions include a number of frames to capture a captured-light image with light including the reflection light received by the light receiver.

### Aspect 10

The distance measuring system according to Aspect 8, further includes another light emitter to emit third light of classical light. The light receiver further receives both of: the reflection light; and another reflection light of the third light reflected from the object. The circuitry is further configured to: receive another information including flight time information based on said another reflection light; and output the analysis results based on the information and said another information.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. A distance measuring system comprising:
circuitry configured to:
calculate quantum correlation information based on first light and second light quantum-entangled with the first light;
perform inference based on the quantum correlation information to obtain inference results; and
output the inference results.

2. The distance measuring system according to claim 1,
wherein the quantum correlation information includes multiple spatially correlated images corresponding to the first light and the second light at different times.

3. The distance measuring system according to claim 1,
wherein the circuitry is further configured to:
infer an object frame corresponding to at least one of the first light or the second light reflected from an object, and
the inference results include information on the object frame.

4. The distance measuring system according to claim 1,
wherein the circuitry is further configured to receive a captured-light image of reflection light of at least one of the first light or the second light reflected from an object.

5. A distance measuring system comprising:
circuitry configured to:
receive information including flight time information based on reflection light of at least one of first light or second light reflected from an object, the first light and the second light being quantum-entangled with each other; and
output analysis results including at least one of:
object frame information about an object frame corresponding to the reflection light from the object;
the flight time information; and
distance information about a distance to the object.

6. The distance measuring system according to claim 5,
wherein the circuitry is further configured to:
calculate quantum correlation information based on the information including the flight time information; and
perform inference based on the quantum correlation information to obtain inference results.

7. The distance measuring system according to claim 5,
wherein the circuitry is further configured to:
receive another information including flight time information based on another reflection light of third light of classical light reflected from the object; and
output the analysis results based on the information and said another information.

8. The distance measuring system according to claim 5, further comprising:
a light emitter to emit the first light and the second light;
a light receiver to receive the reflection light; and
another circuitry configured to control the light emitter and the light receiver,
wherein the circuitry is further configured to:
calculate driving conditions for the light emitter and the light receiver, based on the analysis results; and
output a driving signal corresponding to the driving conditions, to said another circuitry.

9. The distance measuring system according to claim 8,
wherein the driving conditions include a number of frames to capture a captured-light image with light including the reflection light received by the light receiver.

10. The distance measuring system according to claim 8, further comprising another light emitter to emit third light of classical light,
wherein the light receiver further receives both of:
the reflection light; and
another reflection light of the third light reflected from the object, and
the circuitry is further configured to:
receive another information including flight time information based on said another reflection light; and
output the analysis results based on the information and said another information.
